(19) United States
(12) Patent Application Publication
(10) Pub. No.: US 2017/0172125 A1
(43) Pub. Date: Jun. 22, 2017

(54) FISHING-LURE ENHANCED RATTLE APPARATUS AND METHOD

(71) Applicant: Shelby LaCroix, Houston, TX (US)

(72) Inventor: Shelby LaCroix, Houston, TX (US)

(21) Appl. No.: 14/978,950

(22) Filed: Dec. 22, 2015

(51) Int. Cl. A01K 85/01

(52) U.S. Cl. CPC A01K 85/01

(57) ABSTRACT

A fishing-lure enhanced rattle apparatus and method for use on a fishing line ahead of a fishing hook, having a resonant shell, resonant sleeve, and resonant beads making intermittent and repeating contact with each other and with the fishing line, generating sound patterns attractive to fish, optionally allowing for inclusion, exclusion, or partial exclusion of water from the interior of the resonant shell for modification of generated sound patterns or of buoyancy.

### BACKGROUND OF THE INVENTION

This invention provides a fishing-lure enhanced rattle apparatus and method for use on a fishing line ahead of a fishing hook.

Fish are found to be attracted to certain sounds, which are thought to be sounds mimicking natural sounds produced by creatures that fish feed upon. Fishing lures exist that “rattle” with sounds approximating natural sounds, but all such sounds suffer in some degree from a tendency to belie their mechanical means of sound generation, which in turn produces sounds that are less complex, less organic, and more mechanical than the desired natural sounds.

Sound moves through water differently than it moves through air because water transmits sound differently than air does. Specifically, water transmits sound more effectively than air does, and the incorporation of water-tight compartments of air in existing fishing lures can have the effect of dampening either the total sound produced or dampening specific desired frequencies of sound produced.

U.S. Pat. No. 4,995,189, issued Feb. 26, 1991 to Crihfield on a “Rattling Fish Lure,” discloses a noise making fishing lure including a two piece plastic shell assembly having two chambers therein. Each chamber contains a plurality of metal spheres which move as the lure is pulled through the water.

A fishing lure with enhanced rattle sound production and transmission, producing more natural sound and transmitting such sound more effectively, is needed.

### SUMMARY OF THE INVENTION

The present invention provides a fishing-lure enhanced rattle apparatus and method for use on a fishing line ahead of a fishing hook, having a resonant shell, resonant sleeve, and resonant beads making intermittent and repeating contact with each other and with the fishing line, generating sound patterns attractive to fish, which optionally allows for inclusion, exclusion, or partial exclusion of water from the interior of the resonant shell for modification of generated sound patterns or of buoyancy.

The present invention solves existing problems of non-optimal buoyancy and non-optimal sound-pattern generation and transmission through water seen in existing devices.

### BRIEF DESCRIPTION OF DRAWINGS

Reference will now be made to the drawings, wherein like parts are designated by like numerals, and wherein:

FIG. 1 is a schematic view of the fishing-lure enhanced rattle invention;

FIG. 2 is a schematic view of the fishing-lure enhanced rattle invention in use on fishing line ahead of a fishing hook;

FIG. 3 is an illustration of possible shapes of embodiments of the fishing-lure enhanced rattle invention;

FIG. 4 is a schematic cutaway view of the fishing-lure enhanced rattle invention in use on fishing line;

FIG. 5 is a schematic view of the fishing-lure enhanced rattle invention in use, with fishing line making contact at the shell-sleeve joins;

FIG. 6 is a schematic view of the fishing-lure enhanced rattle invention in use, with fishing line vibrating within the resonant sleeve;

FIG. 7 is a schematic view of an embodiment of the fishing-lure enhanced rattle invention having no water ports to allow water into the resonant shell; and

FIG. 8 is a schematic view of an embodiment of the fishing-lure enhanced rattle invention having an additional intermediate chamber.

### DETAILED DESCRIPTION OF THE INVENTION

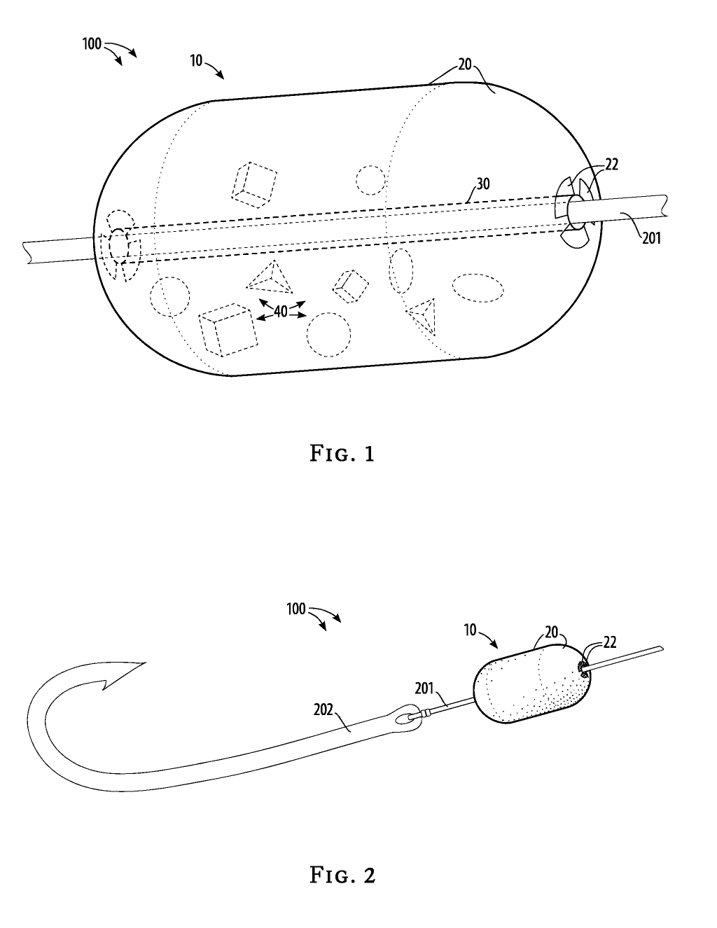

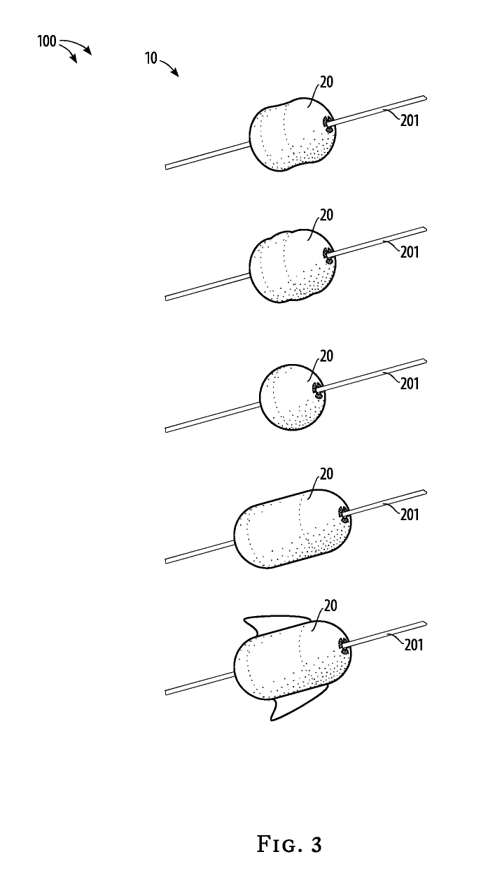

Referring to FIG. 1 and all figures generally, the fishing-lure enhanced rattle method 100 and apparatus 10 are shown schematically. The fishing-lure enhanced rattle 10 is meant to be placed on fishing line 201 near the fishing hook 202, as illustrated in FIG. 2. Where the fishing hook is incorporated into a fishing lure, the fishing-lure enhanced rattle can be placed near the lure, or on or within the lure.

The fishing-lure enhanced rattle provides a resonant shell 20 which defines a resonant chamber within the fishing-lure enhanced rattle 10. A nominally forward hole and a nominally rearward hole in the resonant shell allow passage of the fishing line 201 through the fishing-lure enhanced rattle 10.

A resonant sleeve 30 is provided, which runs from the forward hole to the rearward hole, through the resonant chamber defined by the resonant shell 20. This resonant sleeve isolates the path immediately around the fishing line from the resonant chamber.

One or more resonant beads 40 are provided within the resonant chamber, contained between the resonant shell 20 and the resonant sleeve 30, such that the beads can move, roll, and tumble around within the resonant chamber. In use, these resonant beads will intermittently and repeatedly strike against the resonant shell 20 and the resonant sleeve 30, and, if more than one bead is provided, against other resonant beads 40.

Where more than one resonant bead 40 is provided, which is a preferred embodiment, the beads can be made of different resonant materials and can be made in different shapes and sizes from one another. The different masses of different resonant materials generate a variety of resulting sound frequencies, and therefore provide more complex, more lifelike, less mechanical sound frequencies overall. The different shapes and sizes cause the different beads to move, roll, and tumble in different patterns and at different rates, and therefore provide more complex, more lifelike, and less mechanical sound patterns overall.

A variety of materials are suitable for making the resonant shell, sleeve, and beads of the invention. Plastics and non-rusting metals are suitable. The sound-resonant characteristics of the material or materials, in the sizes and shapes and for the purposes intended, is important. Additionally, the material for the resonant shell 20 should be rigid enough to function properly as an outer shell, the material for the resonant sleeve 30 should be flexible enough to respond to vibration of the fishing line and turbulence in the flow of water across the surface of the sleeve, and the material for the resonant beads should be of a sufficient density to promote movement of the beads and, if needed, to increase or decrease the overall buoyancy of the fishing-lure enhanced rattle 10.

Materials meeting the sound-resonance requirements are likely to be water-impermeable (because a soggy material would have little resonance) and consequently the assembled resonant shell 20 and resonant sleeve 30 would be likely to form a water-tight resonant chamber. Such a water-tight chamber might either present too much buoyancy, if permanently filled with air, or might fail to benefit from the flow of water in use, if permanently filled with water or liquid. An embodiment of this invention provides one or more water ports 22 into the resonant chamber in order to allow water into the chamber and to allow a flow of water through the chamber. Another embodiment of this invention, illustrated in FIG. 7, does not provide water ports, and is appropriate where exclusion of water from the resonant chamber is desired, where permanent filling with water or other substance is desired, or where the materials used for the resonant shell 20 or resonant sleeve 30 are water-permeable.

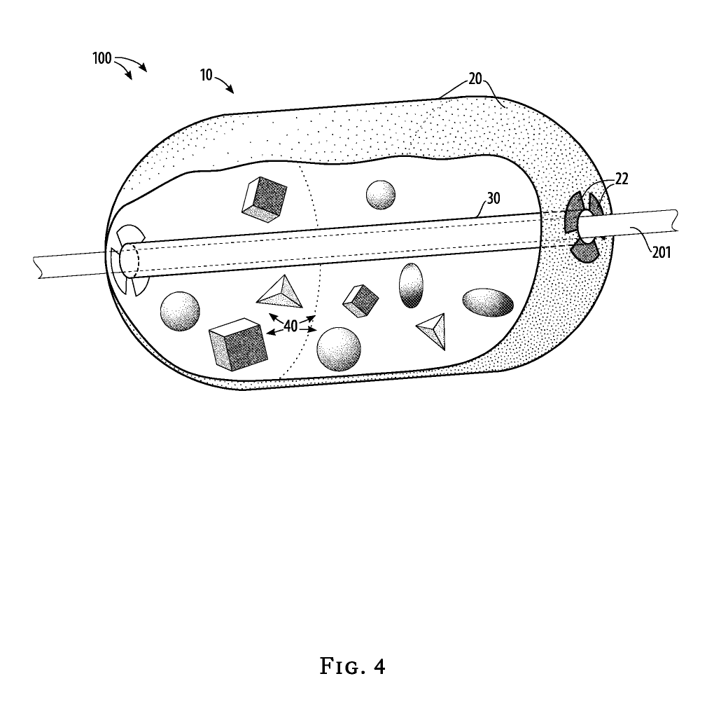

Referring to FIG. 3, the overall shape and configuration of the fishing-lure enhanced rattle is basically that of a smooth capsule, but can vary, depending mostly upon considerations of whether it is desirable in any given embodiment to increase internal or external water-flow turbulence with convex or concave portions, to decrease stability of travel by equalizing the dimensions, or to increase stability of travel by adding fins.

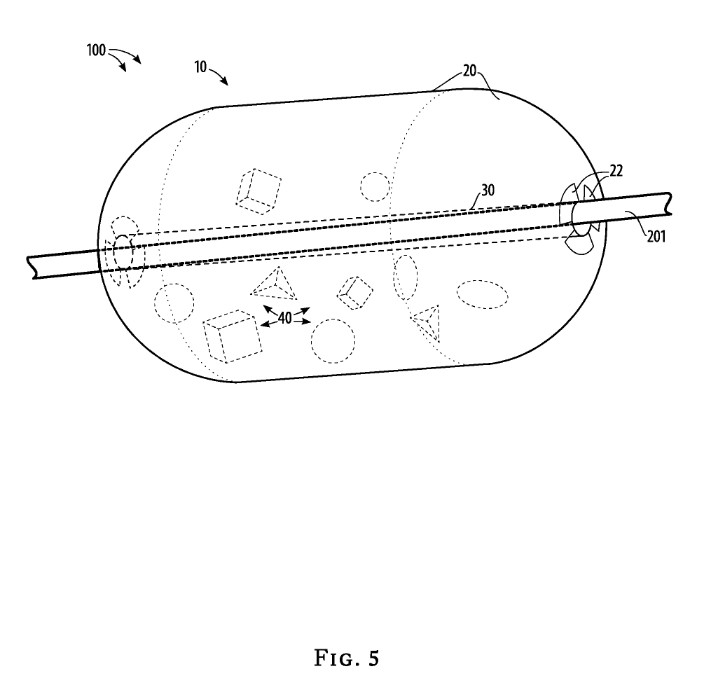

Referring to FIG. 4, illustrating a variety of resonant beads 40 in different materials, sizes, and shapes, in use, the resonant beads 40 move around within the resonant chamber defined by the resonant shell 20 and sealed by the resonant sleeve 30. This movement of resonant beads is caused in part by small variations in movement of the overall fishing-lure enhanced rattle through the water on the fishing line. In embodiments having water ports 22 this movement of resonant beads is also influenced by the flow of water through the resonant chamber. The resonant beads intermittently and repeatedly strike the resonant shell 20, the resonant sleeve 30, and other resonant beads 40 when the invention is in use. Each such strike produces a sound according to the sound-resonance properties of the striking and stricken components. As disclosed above, the sound-resonance properties are chosen to provide varied specific sounds which combine into complex, more organic, less mechanical overall sounds. The varied movement of the invention through the water, enhanced by varied sizes and shapes of resonant beads 40, provides a varied timing of the occurrences of specific sounds, which combine into complex, more organic, less mechanical overall sound patterns.

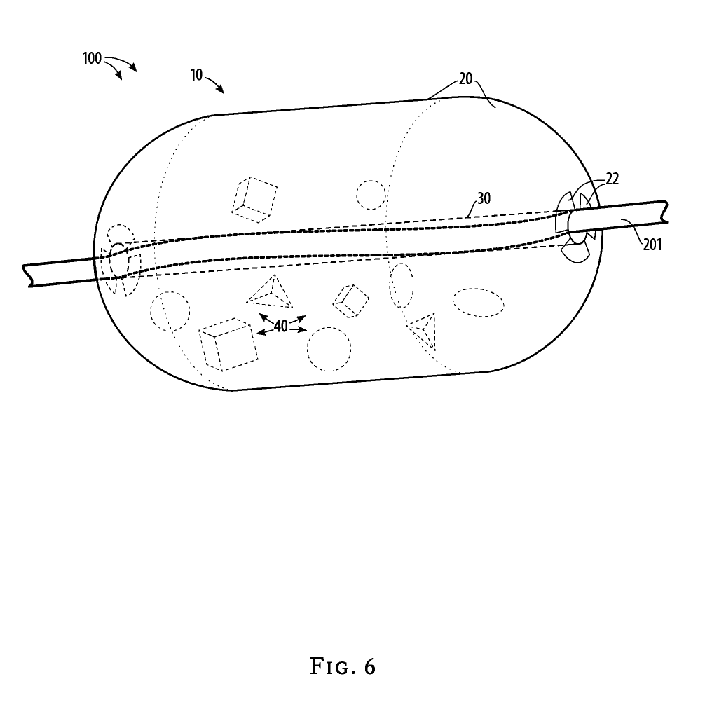

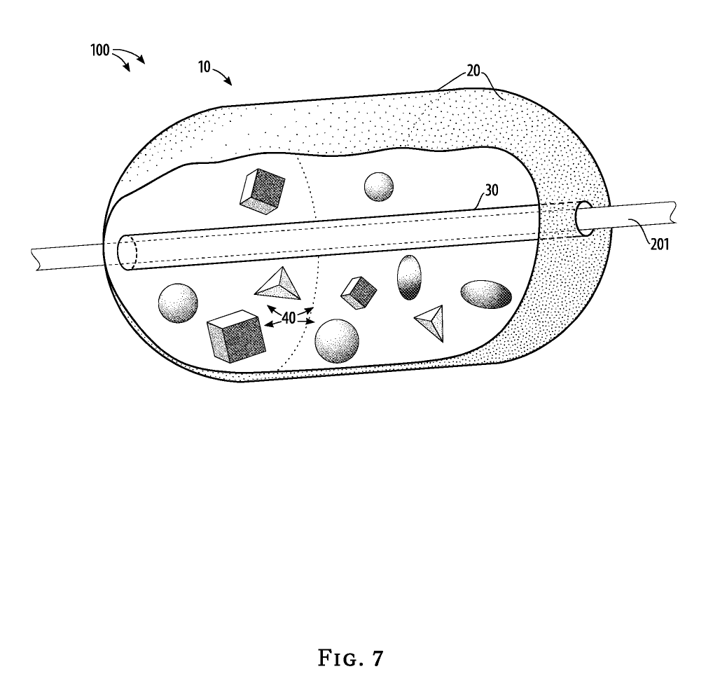

Fishing line and guitar strings are made of similar materials—nylon or plastic monofilament or steel—and fishing line makes a sonic contribution to the fishing-lure enhanced rattle. Referring to FIG. 5 and FIG. 6, the fishing line 201 passes through the resonant sleeve 30. When the fishing line is perfectly aligned with the center of the sleeve, the line and the sleeve do not touch. But, in use, such a perfect alignment is infrequent and short-lived, and with very slight changes in relative alignment at least one part of the resonant sleeve will come into contact with the fishing line. When this contact occurs, the resonant sleeve both influences the sound-producing vibration present on the fishing line, analogous to fretting or producing a harmonic on a guitar string, and receives and resonates sound-producing vibration from the fishing line, analogous to a tin-can-on-a-string communication device or a resonator guitar. In use, water will flow through the resonant sleeve 30 around the fishing line 201. Under favorable conditions, the resonant sleeve 30 and the fishing line 201 will function similarly to a vibrating reed in a musical instrument. This influence upon and transmission of sound waves adds to the fishing-lure enhanced rattle a variety of sounds all in a different category from the sounds generated by the resonant beads 40.

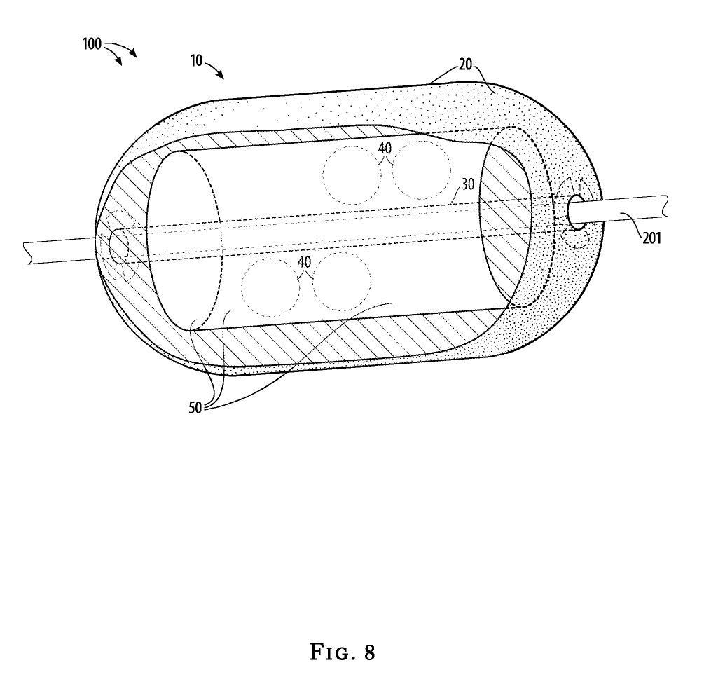

Referring to FIG. 8, in an embodiment, an intermediate chamber 50 can be provided by segregating part of the resonant chamber closest to the resonant sleeve 30. Such an intermediate chamber can be used where it is desirable to constrain the resonant beads 40 closer to the sleeve, where it is desirable to have, for instance, an intermediate chamber containing air and no water and the remainder of the resonant chamber containing water, or vice versa, or where the intermediate chamber provides a desirable filtering or modification of the sound.

Many changes and modifications can be made in the present invention without departing from the spirit thereof. I therefore pray that my rights to the present invention be limited only by the scope of the appended claims.

I claim:

1. A fishing-lure enhanced rattle apparatus for use on fishing line ahead of a fishing hook to produce desirable sound patterns under water, the fishing-lure enhanced rattle comprising:
(i) a resonant shell defining a resonant enclosure and having passage holes at a nominally forward and rearward end;
(ii) a resonant sleeve mounted inside said resonant shell from said forward passage hole to said rearward passage hole, adapted to allow the passage through of the fishing line, adapted to intermittently come into resonant contact with the fishing line; and
(iii) at least one resonant bead contained within said resonant enclosure defined by said resonant shell, adapted to move within said resonant enclosure making intermittent and repeating resonant contact with said resonant shell and said resonant sleeve;
where said resonant contacts with said resonant shell and said resonant sleeve produce desirable sound patterns when in use under water.

2. The fishing-lure enhanced rattle apparatus of claim 1, further comprising at least two resonant beads adapted to additionally make intermittent and repeating resonant contact with each other.

3. The fishing-lure enhanced rattle apparatus of claim 1, further comprising at least two resonant beads of different size, shape, or material, adapted to yield different sound patterns upon making intermittent and repeating resonant contact with said resonant shell, resonant sleeve, and each other.

4. The fishing-lure enhanced rattle apparatus of claim 1, further comprising at least one water port adapted to allow water into said resonant shell.

5. The fishing-lure enhanced rattle apparatus of claim 1, further comprising at least one water port adapted to allow water into said resonant shell, where said allowance of water into said resonant shell causes a desirable decrease to the level of buoyancy of the fishing-lure enhanced rattle in use.

6. The fishing-lure enhanced rattle apparatus of claim 1, further comprising at least one water port adapted to allow water into said resonant shell, where said allowance of water into said resonant shell causes a desirable modification of sound patterns generated and transmitted through water, in use.

7. The fishing-lure enhanced rattle apparatus of claim 1, further comprising an intermediate chamber adapted to constrain said resonant beads closer to said resonant sleeve.

8. The fishing-lure enhanced rattle apparatus of claim 1, further comprising an intermediate chamber adapted to modify ultimately emitted sound patterns transmitted through the interface of said intermediate chamber and said resonant shell defining said resonant enclosure.

9. The fishing-lure enhanced rattle apparatus of claim 1, further comprising an intermediate chamber adapted to exclude water entering said resonant shell through at least one water port.

10. The fishing-lure enhanced rattle apparatus of claim 1, wherein said resonant shell, resonant sleeve, and resonant beads are made from plastic materials.

11. The fishing-lure enhanced rattle apparatus of claim 1, wherein said resonant shell, resonant sleeve, and resonant beads are made from metal materials.

12. A fishing-lure enhanced rattle method, comprising:
(i) providing a fishing-lure enhanced rattle apparatus comprising:
(a) a resonant shell defining a resonant enclosure and having passage holes at a nominally forward and rearward end;
(b) a resonant sleeve mounted inside said resonant shell from said forward passage hole to said rearward passage hole, adapted to allow the passage through of the fishing line, adapted to intermittently come into resonant contact with the fishing line; and
(c) at least one resonant bead contained within said resonant enclosure defined by said resonant shell, adapted to move within said resonant enclosure making intermittent and repeating resonant contact with said resonant shell and said resonant sleeve,
where said resonant contacts with said resonant shell and said resonant sleeve produce desirable sound patterns when in use under water; and
(ii) using said fishing-lure enhanced rattle apparatus on a fishing line ahead of a fishing hook,
consequently producing desirable sound patterns under water.

13. The fishing-lure enhanced rattle method of claim 12, where said fishing-lure enhanced rattle apparatus further comprises at least two resonant beads adapted to additionally make intermittent and repeating resonant contact with each other.

14. The fishing-lure enhanced rattle method of claim 12, where said fishing-lure enhanced rattle apparatus further comprises at least two resonant beads of different size, shape, or material, adapted to yield different sound patterns upon making intermittent and repeating resonant contact with said resonant shell, resonant sleeve, and each other.

15. The fishing-lure enhanced rattle method of claim 12, where said fishing-lure enhanced rattle apparatus further comprises at least one water port adapted to allow water into said resonant shell.

16. The fishing-lure enhanced rattle method of claim 12, where said fishing-lure enhanced rattle apparatus further comprises an intermediate chamber.

17. The fishing-lure enhanced rattle method of claim 12, wherein said resonant shell, resonant sleeve, and resonant beads are made from plastic materials.

18. The fishing-lure enhanced rattle method of claim 12, wherein said resonant shell, resonant sleeve, and resonant beads are made from metal materials.

19. The fishing-lure enhanced rattle method of claim 12, where said fishing-lure enhanced rattle apparatus is placed near a fishing lure.

20. The fishing-lure enhanced rattle method of claim 12, where said fishing-lure enhanced rattle apparatus is placed within a fishing lure.
